(19) United States
(12) Patent Application Publication
(10) Pub. No.: US 2009/0204966 A1
(43) Pub. Date: Aug. 13, 2009

(54) UTILITY FOR TASKS TO FOLLOW A USER FROM DEVICE TO DEVICE

(76) Inventors: Conrad J. Johnson, Pflugerville, TX (US); Perry L. Statham, Round Rock, TX (US); Sandra L. Tipton, Austin, TX (US); Krishna K. Yellepeddy, Austin, TX (US)

Correspondence Address: IBM CORP. (WIP);c/o WALDER INTELLECTUAL PROPERTY LAW, P.C., 17330 PRESTON ROAD, SUITE 100B, DALLAS, TX, 75252, US

(21) Appl. No.: 12/029,490

(22) Filed: Feb. 12, 2008

(51) Int. Cl. G06F 9/46

(52) U.S. Cl. 718/100

(57) ABSTRACT

A “follow-me” utility runs on each of a plurality devices a person may typically use. This utility monitors applications running on a device and intelligently saves the state of tasks a user is performing. When the follow-me utility detects that the user has initialized another device having the follow-me utility and connectivity to the original device, the utility automatically and transparently creates an environment on the new device so that the user may continue the task at the same point as when he or she last performed the task on the original device. When the user continues a task or starts a new task, the follow-me utility automatically and transparently updates files and task states on any devices having the follow-me utility and connectivity. The follow-me utility may make intelligent task migration decisions based on conditions such as network bandwidth, security policy, location, and device capability.

### BACKGROUND

1. Technical Field

The present application relates generally to an improved data processing system and method. More specifically, the present application is directed to a method and utility for tasks to follow a user from device to device.

2. Description of Related Art

Currently, when a user is performing a task on a device, such as a desktop machine, and the user wants to continue the task on another device, such as a personal digital assistant (PDA), a laptop, or a desktop computer in another location, the user must follow a tedious process in order to save the state of the task and continue the task on the other device. A task may comprise an application and the data and state associated with the application, such as editing a document, reading an electronic mail message, browsing a Web document, modifying source code, or processing a set of forms, for example. Often, not all of the task state, such as cursor location in a document, page being viewed, or window location and size relative to the screen, is saved and must instead be recreated by the user after the transfer to the other device.

One current solution to this problem includes making the task fully server based so that only a thin, stateless client is needed to perform the task. This solution may include storing the document for use on a different device, but does not include the task state information or translating the task state to the capabilities and parameters of the new device. This solution also requires a server infrastructure that may be quite costly. The solution also requires continuous network connectivity to the server for all devices involved. Furthermore, this solution does not apply well to tasks or applications that are not client-server enabled.

Another solution may include running the application in a virtual machine that may be check-pointed, stopped, and then restarted on the new device. However, each device the user wants to perform the task on must be capable of hosting the entire virtual machine, even though the user is only interested in the specific task. Furthermore, the user must stilt perform a tedious process to migrate the virtual machine from one device to another.

One popular solution today is to leave the task application running on one original device and to have the new device take over the user interface (UI) of the original device. One drawback of this solution is that it requires continuous network connectivity to the original device. The UI of the new device must be capable of handling the UI of the application designed to run on the original device. For example, if the task is updating some cells in a spreadsheet, and the spreadsheet window on the original device is 1024 pixels by 768 pixels (1024×768) in size, and the new device is a PDA, then the PDA must have a display that is at least 1024×768 or the PDA must scale the 1024×768 window down while still making it readable. Furthermore, the responsiveness of the UI is limited by network bandwidth.

It is possible that an application itself may be intelligent with respect to task state and user data. If so, an application may checkpoint the task state and user data when periodically saving the file. Such applications do not allow the user to restore the state of a task on one machine using a checkpoint from another machine. Furthermore, this solution only works for one such application, and only on one device.

### SUMMARY

In one illustrative embodiment, a method for migrating a task between devices comprises identifying a task currently executing on a first device. The method comprises saving task state information associated with the task on the first device. Responsive to a second device establishing a communicative coupling with the first device, the method automatically transfers the task state information to the second device. The method further comprises automatically initializing the task on the second device according to the task state information so that the task can resume execution at a point at which the task was transferred to the second device.

In another illustrative embodiment, a system within a first device comprises a processor in the first device and a memory in the first device. The memory comprises instructions, which when executed by the processor, cause the processor to identify a task currently executing on the first device. The instructions further cause the processor to save task state information associated with the task on the first device. Responsive to a second device establishing a communicative coupling with the first device, The instructions cause the processor to automatically transfer the task state information to the second device such that the second device automatically initializes the task on the second device according to the task state information so that the task can resume execution at a point at which the task was transferred to the second device.

In another illustrative embodiment, a computer program product comprises a computer useable medium having a computer readable program. The computer readable program, when executed on a computing device, causes the computing device to identify a task on the first device. The computer readable program causes the computing device to save task state information associated with the task on the first device. Responsive to a second device establishing a communicative coupling with the first device, the computer readable program causes the computing device to automatically transfer the task state information to the second device such that the second device automatically initializes the task on the second device according to the task state information so that the task can resume execution at a point at which the task was transferred to the second device.

These and other features and advantages of the present invention will be described in, or will become apparent to those of ordinary skill in the art in view of, the following detailed description of the exemplary embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 depicts a pictorial representation of an exemplary distributed data processing system in which aspects of the illustrative embodiments may be implemented;

FIG. 2 is a block diagram of an exemplary data processing system in which aspects of the illustrative embodiments may be implemented;

FIG. 3 is a block diagram illustrating a utility to allow a task to follow a user from device to device in accordance with an illustrative embodiment;

FIGS. 4A-4D illustrate example implementations of a follow-me utility on various devices in accordance with an exemplary embodiment;

FIGS. 5A-5C illustrate an example implementation of a follow-me utility in accordance with an exemplary embodiment;

FIGS. 6A and 6B are diagrams illustrating replication of documents with state information in accordance with an illustrative embodiment;

FIG. 7 is a flowchart illustrating operation of a follow-me utility in accordance with an illustrative embodiment; and

FIG. 8 is a flowchart illustrating operation when a user migrates from one device to another using a follow-me utility in accordance with an illustrative embodiment.

### DETAILED DESCRIPTION OF THE ILLUSTRATIVE EMBODIMENTS

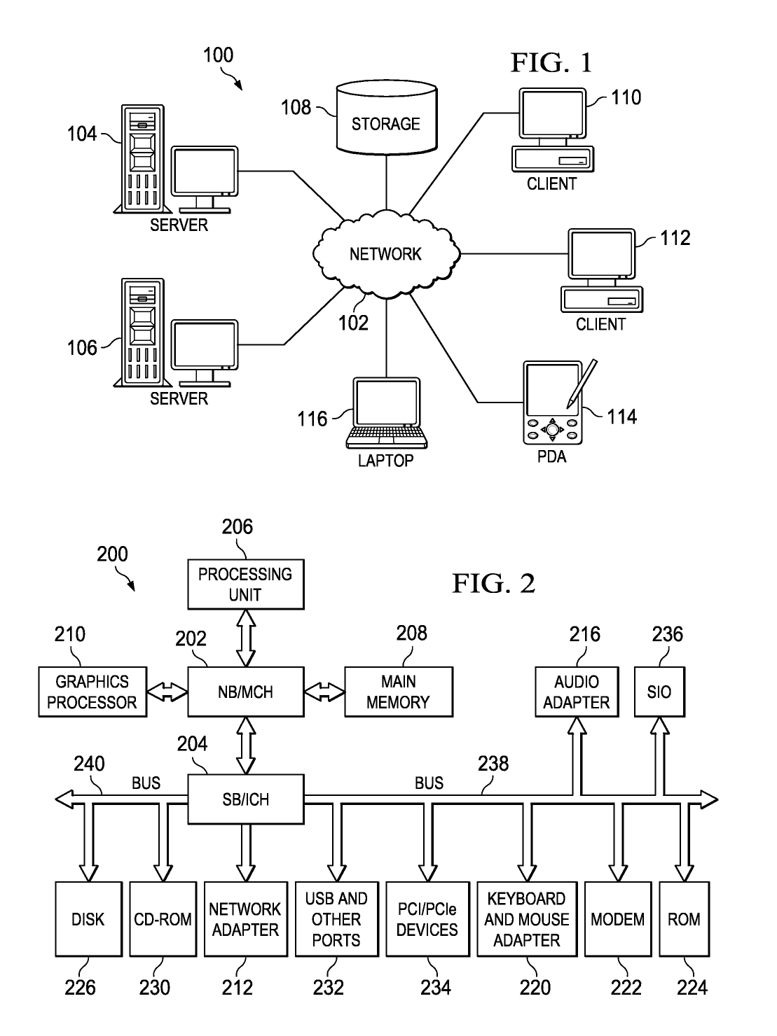

With reference now to the figures and in particular with reference to FIGS. 1-2, exemplary diagrams of data processing environments are provided in which illustrative embodiments of the present invention may be implemented. It should be appreciated that FIGS. 1-2 are only exemplary and are not intended to assert or imply any limitation with regard to the environments in which aspects or embodiments of the present invention may be implemented. Many modifications to the depicted environments may be made without departing from the spirit and scope of the present invention.

With reference now to the figures, FIG. 1 depicts a pictorial representation of an exemplary distributed data processing system in which aspects of the illustrative embodiments may be implemented. Distributed data processing system 100 may include a network of computers in which aspects of the illustrative embodiments may be implemented. The distributed data processing system 100 contains at least one network 102, which is the medium used to provide communication links between various devices and computers connected together within distributed data processing system 100. The network 102 may include connections, such as wire, wireless communication links, or fiber optic cables.

In the depicted example, server 104 and server 106 are connected to network 102 along with storage unit 108. In addition, clients 110-116 are also connected to network 102. These clients 110-116 may be, for example, personal computers, network computers, or the like. In the depicted example, clients 110 and 112 are desktop computers; client 114 is a personal digital assistant (PDA); and, client 116 is a laptop computer. Server 104 may provide data, such as boot files, operating system images, and applications to the clients 110-116. Clients 110-116 may be clients to server 104 in the depicted example. Distributed data processing system 100 may include additional servers, clients, and other devices not shown.

In the depicted example, distributed data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, the distributed data processing system 100 may also be implemented to include a number of different types of networks, such as for example, an intranet, a local area network (LAN), a wide area network (WAN), or the like. As stated above, FIG. 1 is intended as an example, not as an architectural limitation for different embodiments of the present invention, and therefore, the particular elements shown in FIG. 1 should not be considered limiting with regard to the environments in which the illustrative embodiments of the present invention may be implemented.

In accordance with an illustrative embodiment, clients 110-116 may be connected to one another through network 102 or directly via a wired or wireless connection (not shown). Clients 110-116 may include a wired or wireless network interface, a Bluetooth® interface, a universal serial bus (USB), or the like. For example, PDA 114 may connect directly to client 110 via a USB cable or wireless USB, while PDA 114 may connect to laptop 116 via a Bluetooth® connection. Laptop 116 may then connect to client 112 via a wireless network access point or a crossover cable. Other wired or wireless connections may be used, and the present invention shall not be limited to the examples described herein. “BLUETOOTH” is a trademark of Bluetooth SIG, Inc.

A user may begin a task on one device and wish to continue the task on a different device. A task may comprise an application and the data and state associated with the application, such as editing a document, reading an electronic mail message, browsing a Web document, modifying source code, or processing a set of forms, for example. For example, a user may begin to edit a word processing document on client 110, which is in the user's office, and then leave the office to return home. The user may bring laptop 116 back-and-forth between work and home. In order to continue the task, the user may save the document on a removable storage device, such as a USB storage device, and then transfer the file to laptop 116. The user may then open the file on laptop 116 using the same or a compatible application. However, this process involves several tedious steps, which present opportunity for user error. For instance, the user may copy the wrong file or forget to save the most recent edits. Furthermore, in this particular case, the user must carry an extra device, the removable storage device, to effectuate the transfer. Still further, very little state information is transferred with the file.

Thus, in accordance with the illustrative embodiment, each client 110-116 includes a follow-me utility for storing and transferring task files and state information. The follow-me utility periodically saves the files on which the user is working, along with state information, such as page viewed, cursor location, insert/overwrite, zoom, and the like. When the follow-me utility detects another device with a follow-me utility and connectivity to the instant device, the utility automatically and transparently transfers file updates and state information. Thus, the user may simply pick up the new device and continue the task without having to perform any manual steps to transfer files or initialize an application to arrive at the same state. In other words, the user may simply pick up where he or she left off.

With reference now to FIG. 2, a block diagram of an exemplary data processing system is shown in which aspects of the illustrative embodiments may be implemented. Data processing system 200 is an example of a computer, such as hosts 110 in FIG. 1, in which computer usable code or instructions implementing the processes for illustrative embodiments of the present invention may be located.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206. The operating system coordinates and provides control of various components within the data processing system 200 in FIG. 2. As a client, the operating system may be a commercially available operating system such as Microsoft® Windows® XP (Microsoft and Windows are trademarks of Microsoft Corporation in the United States, other countries, or both). An object-oriented programming system, such as the Java™ programming system, may run in conjunction with the operating system and provides calls to the operating system from Java™ programs or applications executing on data processing system 200 (Java is a trademark of Sun Microsystems, Inc. in the United States, other countries, or both).

As a server, data processing system 200 may be, for example, an IBM® eServer™ pSeries® computer system, running the Advanced Interactive Executive (AIX®) operating system or the LINUX® operating system (eServer, pSeries and AIX are trademarks of International Business Machines Corporation in the United States, other countries, or both while LINUX is a trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for illustrative embodiments of the present invention may be performed by processing unit 206 using computer usable program code, which may be located in a memory such as, for example, main memory 208, ROM 224, or in one or more peripheral devices 226 and 230, for example.

A bus system, such as bus 238 or bus 240 as shown in FIG. 2, may be comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, may include one or more devices used to transmit and receive data. A memory may be, for example, main memory 208, ROM 224, or a cache such as found in NB/MCH 202 in FIG. 2.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system, other than the SMP system mentioned previously, without departing from the spirit and scope of the present invention.

Moreover, the data processing system 200 may take the for of any of a number of different data processing systems including client computing devices, server computing devices, a tablet computer, laptop computer, telephone or other communication device, a personal digital assistant (PDA), or the like. In some illustrative examples, data processing system 200 may be a portable computing device which is configured with flash memory to provide non-volatile memory for storing operating system files and/or user-generated data, for example. Essentially, data processing system 200 may be any known or later developed data processing system without architectural limitation.

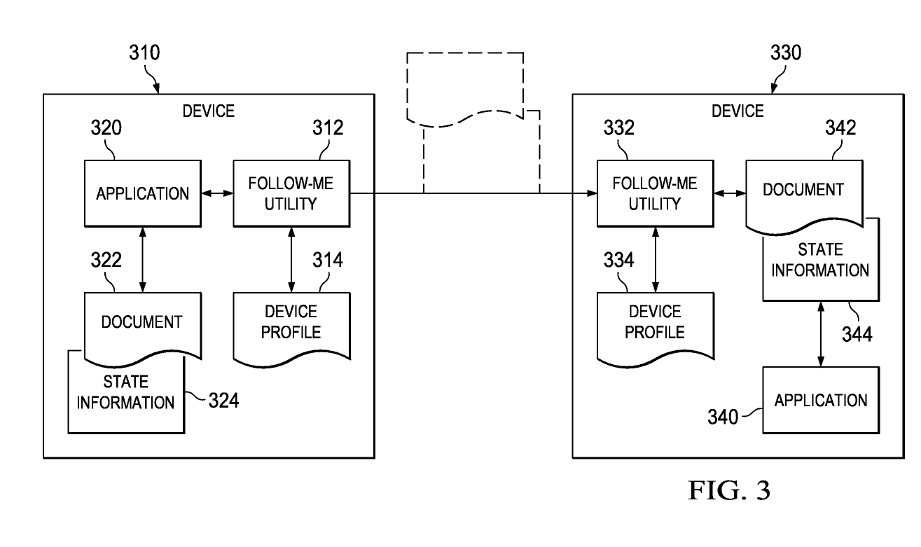

FIG. 3 is a block diagram illustrating a utility to allow a task to follow a user from device to device in accordance with an illustrative embodiment. Device 310 includes follow-me client 312. Device 330 includes follow-me client 332. A user of device 310 may perform a task associated with document 322 using application 320 on device 310. A task may comprise an application and the data and state associated with the application, such as editing a document, reading an electronic mail message, browsing a Web document, modifying source code, or processing a set of forms, for example. Application 320 may be, for example, a word processing application, a presentation application, a spreadsheet application, or the like. Application 320 maintains task state information 324 associated with document 322. State information 324 may include, for example, page being viewed, cursor location, zoom, insert/overwrite, and so forth.

Follow-me utility 312 detects whether another device, such as device 330, has established connectivity, a communicative coupling, with device 310. A communicative coupling may be, for example, a wired network connection, a wireless network connection, a wired direct connection, such as a universal serial bus (USB) connection or an Ethernet connection via a crossover cable, a wireless direct connection, such as a Bluetooth® connection, or the like. In addition, a communicative coupling may require an encryption key, password, digital signature, or the like, to ensure that documents are not copied to other devices owned by other users that happen to have a follow-me utility installed. Thus, the user may enter a key into each follow-me utility of each device to ensure that the follow-me utilities of the user's various devices only talk to each other.

If device 330 has a communicative coupling to device 310 and has follow-me utility 332 active, device 310 sends updates for document 322 and state information 324 to follow-me utility 332 periodically. Follow-me utility 332 stores this information as document 342 and state information 344. Thus, if at any time the user begins using device 330, the user may continue the task by editing or viewing document 342 with state information 344 using application 340.

Device 310 includes device profile 314 and device 330 includes device profile 334. Device profiles 314 and 334 store information about the capabilities and security levels of their respective devices. For example, device 310 may have a screen resolution of 1280×1024 with 24-bit color, while device 330 may have a screen resolution of 1024×768 with 16-bit color. In this instance, follow-me utility 332 may alter the zoom to be proportional to the screen resolution of device 330. As another example, device 330 may not have anti-virus software; therefore, follow-me utility 332 may disable executables, scripts, or other embedded objects in document 342. Furthermore, device profiles 314 and 334 may comprise a configuration policy through which a user may set configuration settings, such as the number of tasks to be restored when a device becomes active, whether errors are displayed or logged, and the like.

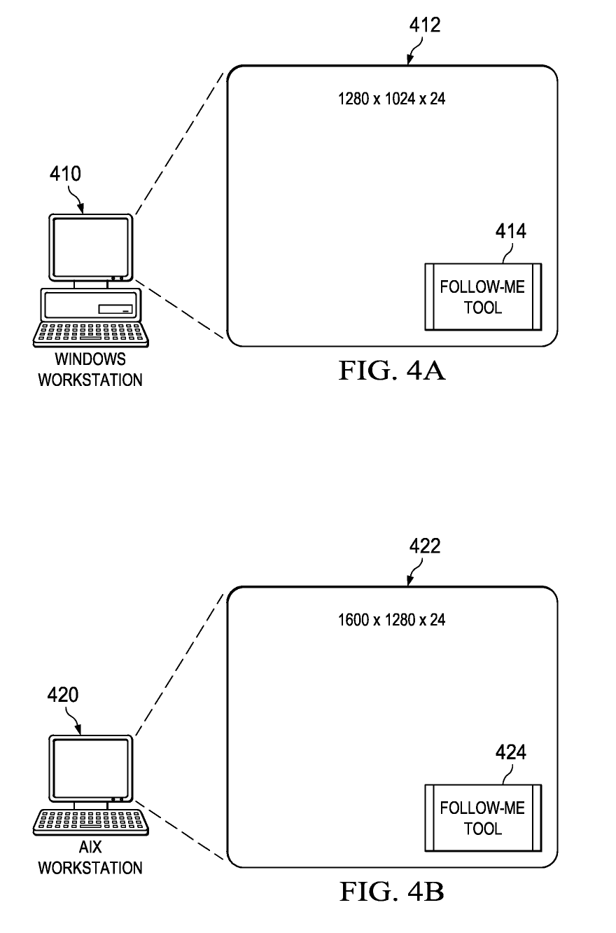

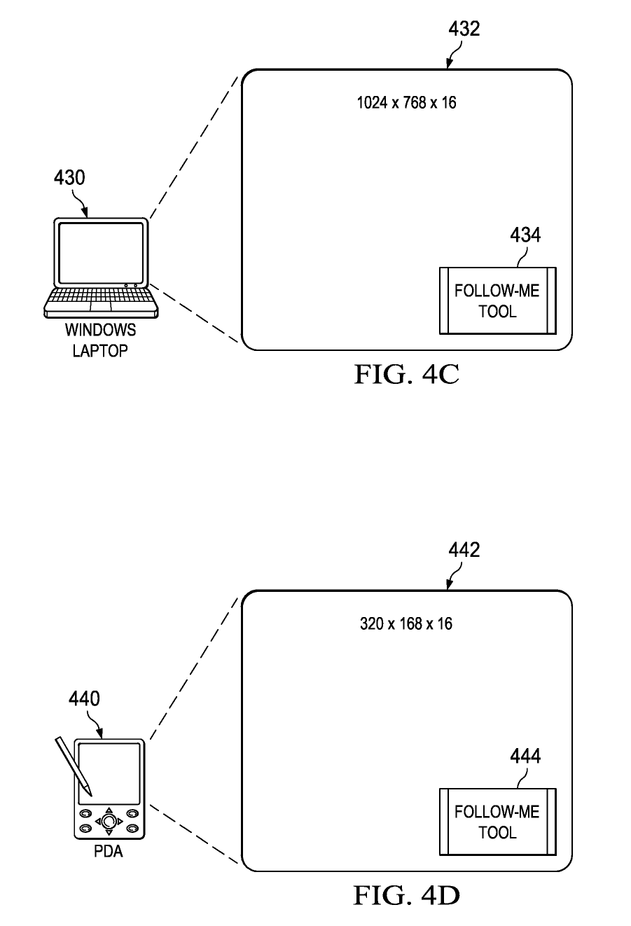

FIGS. 4A-4D illustrate example implementations of a follow-me utility on various devices in accordance with an exemplary embodiment. More particularly, with reference to FIG. 4A, at home, a user works on workstation 410, which has a Windows® operating system and a screen 412 with a resolution of 1280×1024 and 24-bit color. Workstation 410 may have an average speed processor and 1 GB of memory, for example.

Workstation 410 executes a follow-me utility, which may present a graphical control 414, such as an icon, a system tray icon, window, or the like. The user may manage aspects of follow-me utility by interacting with graphical control 414. For example, graphical control 414 may present a right-click menu, a menu bar, a button tool bar, or other controls that are generally known in the art. The user may manipulate these controls to add or remove tasks that are to follow the user from device to device, edit the device profile, modify preferences, such as the information to be included in state information, and the like.

Turning to FIG. 4B, the user may use workstation 420, which has a AIX® operating system and a screen 422 with a resolution of 1600×1280 with 24-bit color. Workstation 420 executes a follow-me utility, which may present graphical control 424 on screen 422. At work, the user uses workstation 420, which may have a very fast processor and 2 GB of memory, for example.

With reference now to FIG. 4C, the user may also use laptop 430, which has a Windows® operating system and a screen 432 with a resolution of 1024×768 with 16-bit color. Laptop 430 executes a follow-me utility, which may present graphical control 434 on screen 432. When in a hotel or at a customer location, the user may use laptop 430, which may have an average speed processor and 512 MB of memory, for example.

With reference to FIG. 4D, the user may also use PDA 440, which has a screen 442 with a resolution of 320×168 with 16-bit color. PDA 440 executes a follow-me utility, which may present graphical control 444 on screen 442. When traveling, the user may use PDA 430, which may have a relatively low speed processor and a small amount of flash memory, for example.

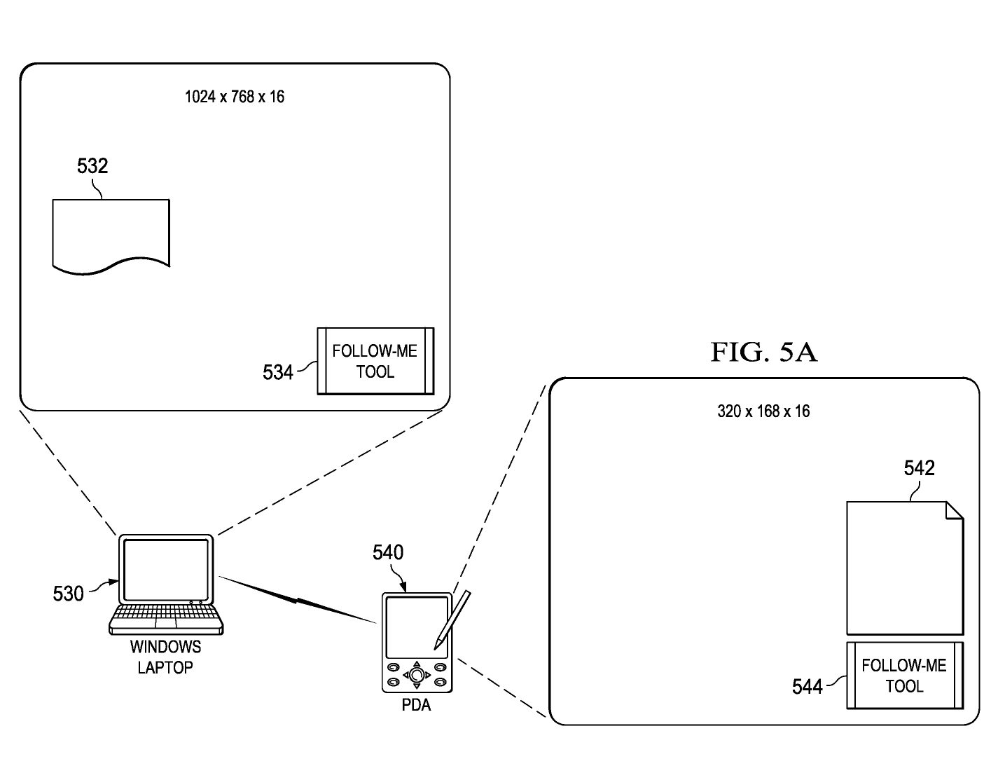

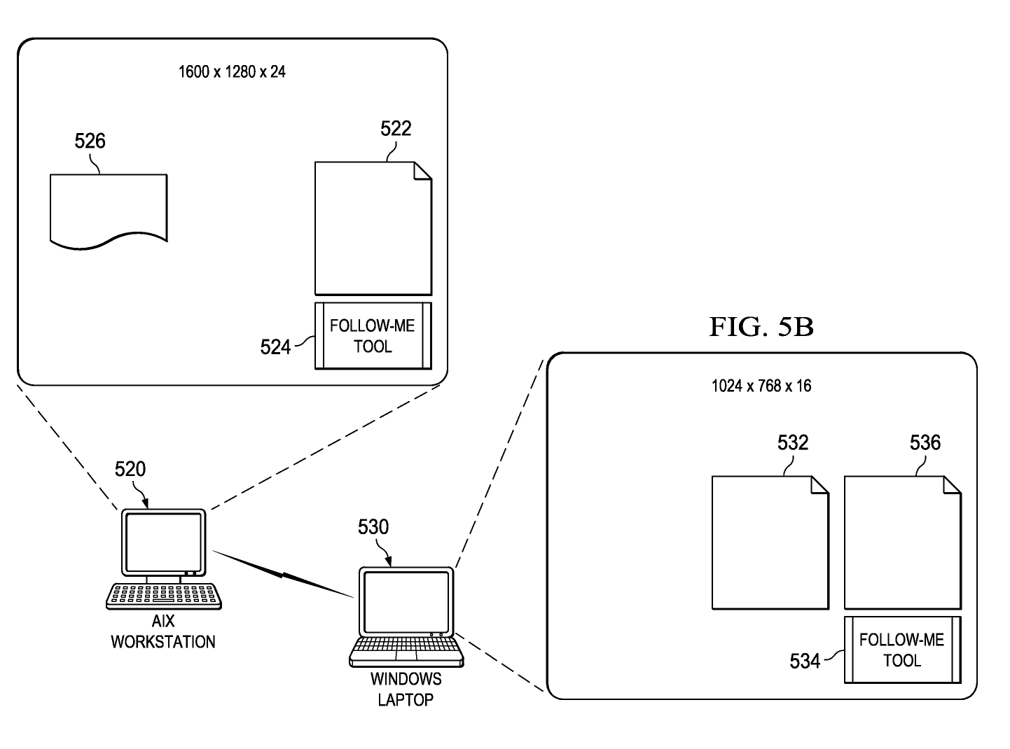

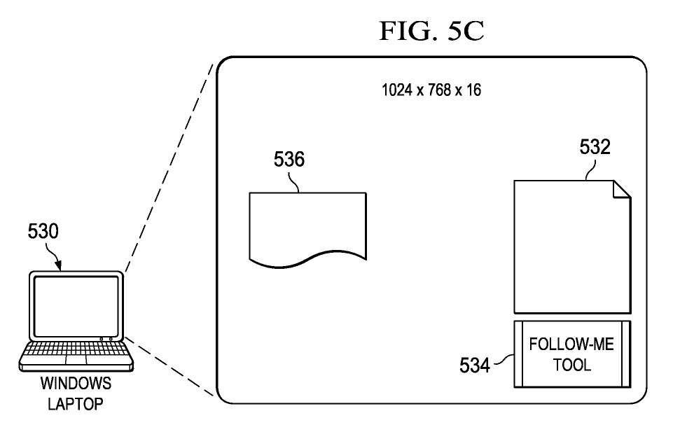

FIGS. 5A-5C illustrate an example implementation of a follow-me utility in accordance with an exemplary embodiment. More particularly, with reference to FIG. 5A, a user travels to a customer's office carrying Windows® laptop 530 and PDA 540. While there, the customer gives the user a word processing document 532, which the user opens on laptop 530 and begins annotating while discussing the document with the customer. The laptop follow-me utility 534 notes that the user has started editing document 532 with a word processing application and begins saving the document insertion point, page being displayed, insert/overwrite mode of the cursor, and the selected text. Because PDA 540 is near laptop 530 and has a communicative coupling via a wireless networking link, follow-me utility 534 on laptop 530 replicates document 532 with state information to follow-me utility 544 on PDA 540. Follow-me utility 544 stores the replicated document with state information 542.

The customer meeting runs over time, so the user wraps up the meeting and leaves for a meeting with another customer. While driving to the next meeting, the user thinks of more annotations to document 542. While stopped at a red light, the user opens PDA 540, which causes follow-me utility 544 to try to communicate with laptop 530. If PDA 540 can communicate with laptop 530, then follow-me utility 534 saves document 532 with state information, closes document 532 in the application on laptop 530, and replicates the updated version of document 532 with task state information to follow-me utility 544. If PDA 540 cannot communicate with laptop 530, then follow-me utility 544 still has a copy of document 542 with state information. Follow-me utility 544 opens document 542 in a compatible application on PDA 540 and restores the state of the task.

The user may then continue making the annotations until the traffic light turns green, at which point, the user closes the PDA case and continues driving. If PDA 540 can communicate with laptop 530, then follow-me utility 544 saves document 542 with current task state information, closes document 542, and replicates document 542 with task state information to follow-me utility 534.

Turning to FIG. 5B, the user arrives at his office and opens laptop 530. Follow-me utility 524 may attempt to perform the same process with laptop 530 to receive replica 522 at workstation 520; however, at this time, the user may not be concerned with document 522. Instead, the user begins working on a storyboard document 526 on workstation 520 using a presentation application. Follow-me utility 524 saves document 526 with task state information and periodically sends a replica to follow-me utility 534 on laptop 530, which stores replica 536. Follow-me utility 534 may also convert document 536 to be compatible with a presentation application on laptop 530 based on a device profile (not shown) for laptop 530.

Conversion may encompass any type of file conversion. For example, workstation 520 may have Microsoft Word® data processing system while laptop 530 may have Sun StarOfficc™ data processing system. In this case, conversion is a simple file format conversion from a Microsoft Word® format to StarOffice™ format. Conversion may also include translating from the formats of different versions of the same application or application suite. In an exemplary embodiment, conversion is performed by the follow-me utility itself, in the above example follow-me utility 534. However, follow-me utility 534, for example, may support plug-in applications to expand the types of supported conversions. Follow-me utility 534, for example, may provision plug-in applications from a provisioning service.

Note that the PDA may also have a communicative coupling to AIX® workstation 520, but the PDA follow-me utility may not store a replica of document 526 because the PDA may not have a compatible presentation application and, thus, may not be capable of performing the presentation task. Alternatively, the PDA follow-me utility may store a replica of document 526 to pass on to another device.

With reference now to FIG. 5C, the user may bring laptop 530 to a second customer's location. The user may then show presentation document 536 to the second customer and make changes to document 536 over the course of the meeting based on suggestions from the second customer. When the meeting ends, the user may close laptop 530 and follow-me utility 534 will store document 536 with the current task state automatically.

Thus, the user may carry various devices from location to location. As long as these devices are running a follow-me utility and can establish a communicative coupling, the follow-me utilities of the devices replicate documents and task state information automatically and transparently. The user can simply pick up a new device and begin where he or she left off.

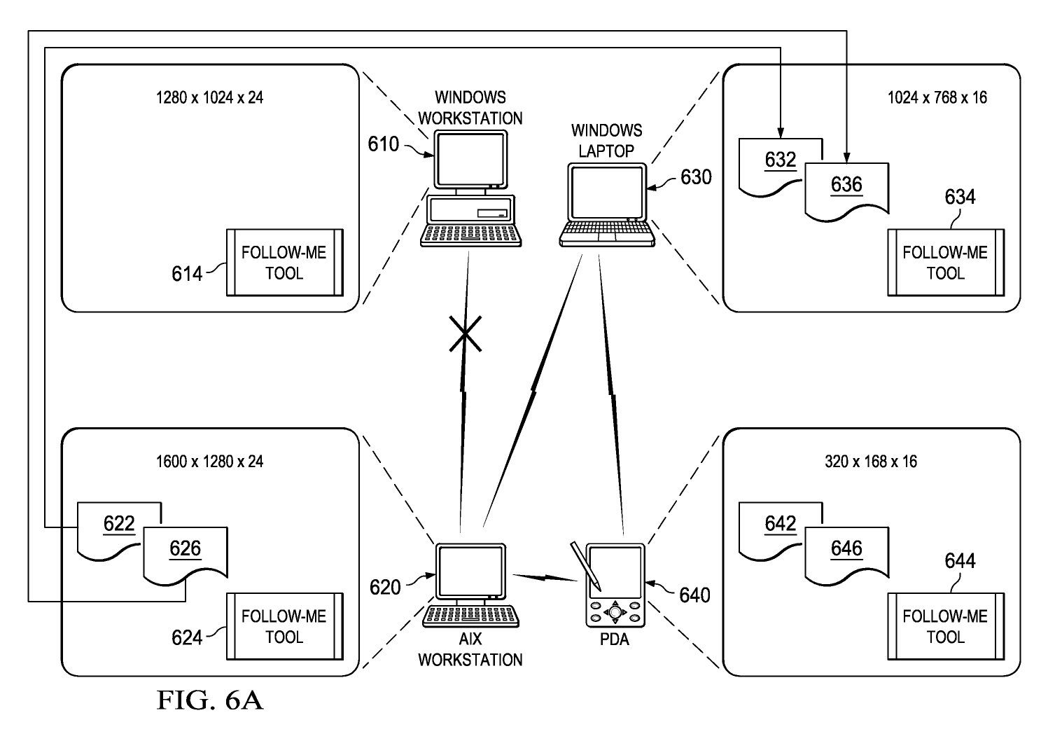

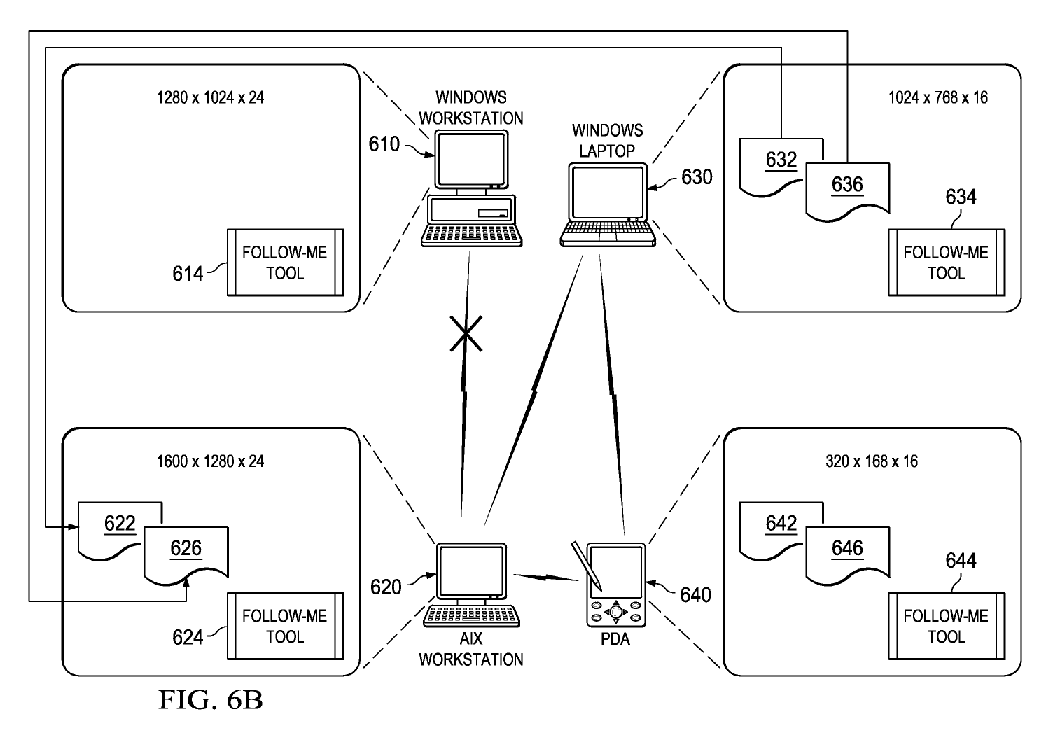

FIGS. 6A and 6B are diagrams illustrating replication of documents with state information in accordance with an illustrative embodiment. With reference to FIG. 6A, Windows® workstation 610 runs follow-me utility 614, AIX® workstation 620 runs follow-me utility 624, Windows® laptop 630 runs follow-me utility 634, and PDA 640 runs follow-me utility 644. In the depicted example, workstation 620 can establish a communicative coupling to laptop 630 and PDA 640. Workstation 620 cannot establish a communicative coupling to workstation 610. For instance workstation 610 and workstation 620 may be in different locations such that a wired or wireless connection cannot be established. Alternatively, workstation 610 and workstation 620 may be in communication with one another, but may have a different encryption key, password, or the like.

The user may begin working on Windows® laptop 630, at which time, follow-me utility 634 replicates documents 622 and 626 from workstation 620 and stores them as documents 632 and 636. In the background and transparent to the user, PDA 640 may also replicate the documents as documents 642 and 646. On laptop 630, the user may begin looking at document 642, for example. The user may simply change the zoom to 75% and scroll through the document until page 32 is displayed.

Turning to FIG. 6B, the user may then walk to another room and begin working on AIX® workstation 620. Follow-me utility 624 recognizes that workstation 620 is the currently active device and replicates documents 632 and 636 from laptop 630 and stores them as documents 622 and 636. When the user opens document 622, follow-me utility ensures that the task state information is transferred such that the application opens the document to page 32 with zoom at 75%.

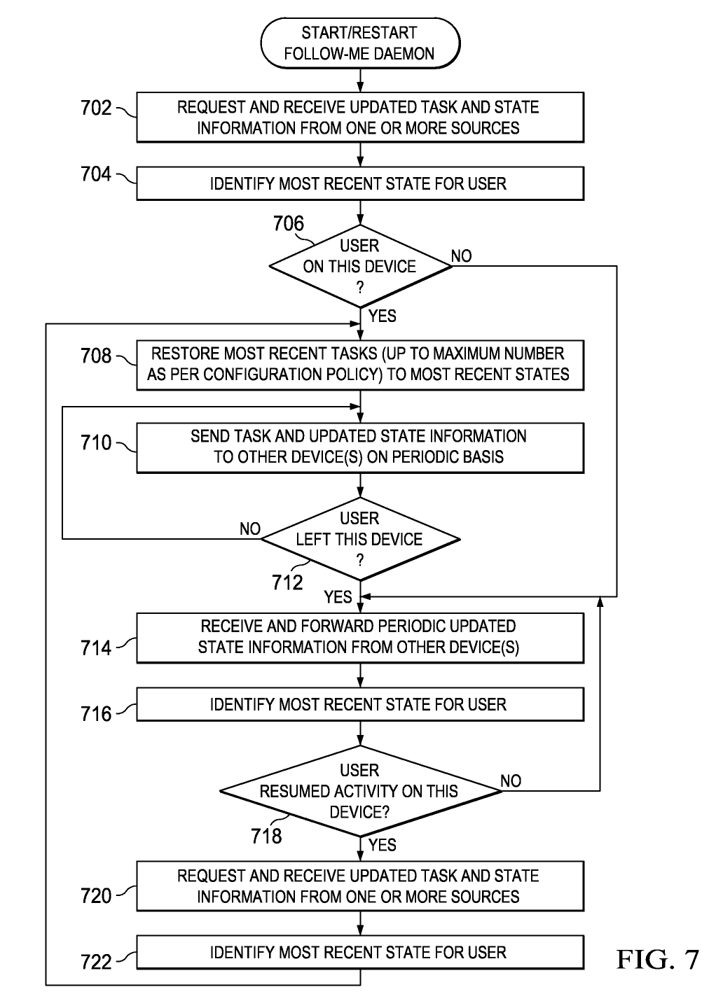

FIG. 7 is a flowchart illustrating operation of a follow-me utility in accordance with an illustrative embodiment. It will be understood that each block of the flowchart illustrations, and combinations of blocks in the flowchart illustrations, can be implemented by computer program instructions. These computer program instructions may be provided to a processor or other programmable data processing apparatus to produce a machine, such that the instructions which execute on the processor or other programmable data processing apparatus create means for implementing the functions specified in the flowchart block or blocks. These computer program instructions may also be stored in a computer-readable memory or storage medium that can direct a processor or other programmable data processing apparatus to function in a particular manner, such that the instructions stored in the computer-readable memory or storage medium produce an article of manufacture including instruction means which implement the functions specified in the flowchart block or blocks.

Accordingly, blocks of the flowchart illustrations support combinations of means for performing the specified functions, combinations of steps for performing the specified functions and program instruction means for performing the specified functions. It will also be understood that each block of the flowchart illustrations, and combinations of blocks in the flowchart illustrations, can be implemented by special purpose hardware-based computer systems which perform the specified functions or steps, or by combinations of special purpose hardware and computer instructions.

Furthermore, the flowcharts are provided to demonstrate the operations performed within the illustrative embodiments. The flowcharts are not meant to state or imply limitations with regard to the specific operations or, more particularly, the order of the operations. The operations of the flowcharts may be modified to suit a particular implementation without departing from the spirit and scope of the present invention.

With reference now to FIG. 7, operation begins when a device starts or restarts the follow-me daemon, which is the executable for the follow-me utility that runs in the background of the device. The follow-me utility requests and receives updated task and state information from one or more sources, if any (block 702). If any other devices have a communicative coupling with the device, then the device will receive updated task and state information. Then, the follow-me utility identifies the most recent state for the user (block 704).

Next, the follow-me utility determines whether the user is still on the instant device (block 706). This determination may be made, for example, by determining whether the device is idle or in sleep mode, whether the user has made a keystroke or mouse movement within a predetermined period of time, or the like. If the user is active on the instant device, then the follow-me utility restores the most recent tasks to a most recent state (block 708). The follow-me utility may restore up to a maximum number of tasks as per a configuration policy, for example. Then, the follow-me utility sends the task and updated state information to one or more other devices, if any are in communicative coupling with the instant device, on a periodic basis (block 710).

Thereafter, the follow-me utility determines whether the user has left the device (block 712). This determination may be similar to the determination in block 706, for example. If the user has not left the instant device, operation returns to block 710 to send task and updated state information to other devices. These operations may repeat as the user continues to perform tasks on the instant device and updated state information is propagated to other devices that are in communicative coupling with the instant device and have a follow-me utility running thereon.

If the user has left the instant device in block 712 or the user is not on the instant device in block 706, then the follow-me utility receives and forwards periodic updated state information from one or more other devices, if other devices are in communicative coupling with the instant device (block 714). Then, the follow-me utility identifies the most recent state for the user (block 716). Next, the follow-me utility determines whether the user has resumed activity on the instant device (block 718). This determination may be similar to the determination in block 706, for example. If the user has not resumed activity on the instant device, operation returns to block 714 to receive and forward periodic updated state information from one or more other devices, if any.

If the user has resumed activity on the instant device in block 718, the follow-me utility requests and receives updated task and state information from one or more sources, if any (block 720) and identifies the most recent state for the user (block 722). Thereafter, operation proceeds to block 708 to restore the most recent tasks to the most recent states.

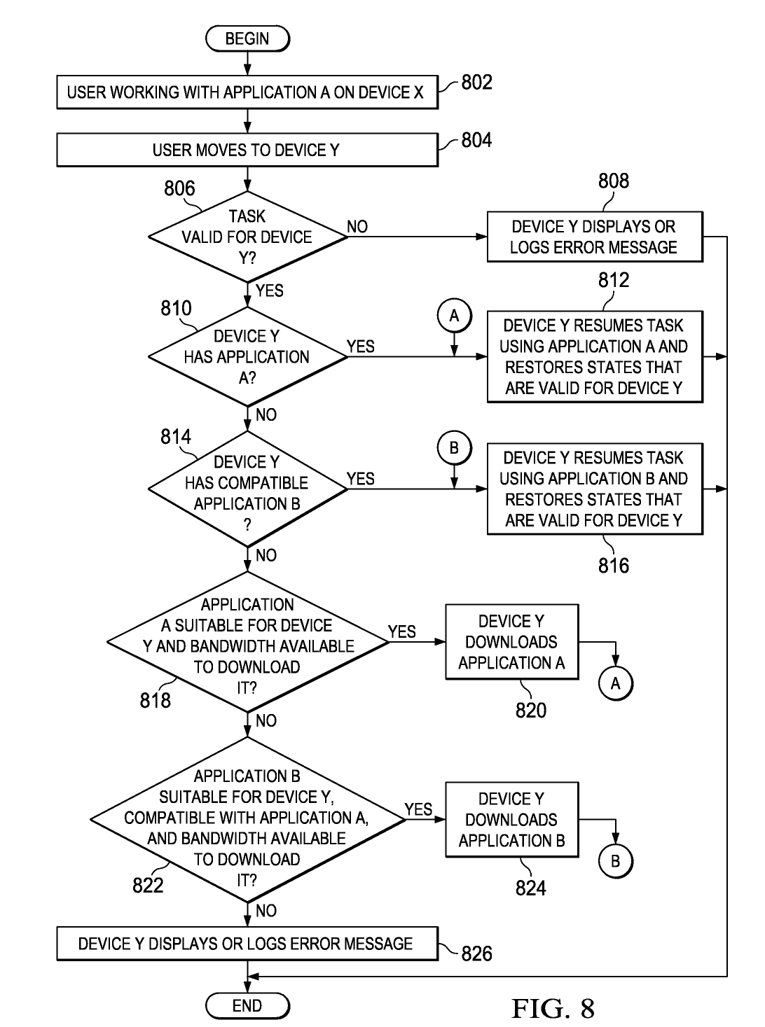

FIG. 8 is a flowchart illustrating operation when a user migrates from one device to another using a follow-me utility in accordance with an illustrative embodiment. Operation begins as a user is working with application A on device X (block 802). Then, the user moves to device Y (block 804). The follow-me utility of device Y determines whether the current task associated with application A is valid for device Y (block 806). If the task is not valid for device Y, then device Y displays or logs an error message (block 808), and operation ends. Whether device Y displays an error message or logs the error message may be configured using the configuration policy.

If the task is valid for device Y in block 806, The follow-me utility of device Y determines whether device Y has application A (block 810). If device Y has application A, then device Y resumes the task using application A and restores the states that are valid for device Y (block 812). Thereafter, operation ends.

If device Y does not have application A in block 810, the follow-me utility determines whether device Y has an application B that is compatible with application A for the task (block 814). If device Y has a compatible application B, then device Y resumes the task using application B and restores the states that are valid for device Y and application B (block 816). Thereafter, operation ends.

If device Y does not have a compatible application B, then the follow-me utility of device Y determines whether application A is suitable for device Y and whether there is enough bandwidth available to download application A (block 818). If application A is suitable for device Y and there is enough bandwidth, then device Y downloads application A (block 820). Then, operation proceeds to block 812 where device Y resumes the task using application A and restores the states that are valid for device Y, and operation ends.

If application A is not suitable for device Y or there is not enough bandwidth to download it in block 818, then the follow-me utility of device Y determines whether application B is suitable for device Y, whether application B is compatible with application A, and whether there is enough bandwidth available to download application B to device Y (block 822). If there is an application B that is suitable for device Y and compatible with application A, and there is enough bandwidth to download it, then device Y downloads application B to device Y (block 824). Then operation proceeds to block 816 where device Y resumes the task using application B and restores the states that are valid for device Y and application B (block 816), and operation ends.

If there is not an application B that is suitable for device Y, there is not an application B that is compatible with application A, or there is not enough bandwidth to download such an application B in block 822, then device Y displays or logs an error message (block 826). Thereafter, operation ends.

Thus, the illustrative embodiments solve the disadvantages of the prior art by providing a “follow-me” utility that runs on each of the devices a person may typically use. This utility monitors applications running on a device and intelligently saves the state of tasks a user is performing. When the follow-me utility detects that the user has initialized another device having the follow-me utility and connectivity to the original device, the utility automatically and transparently creates an environment on the new device so that the user may continue the task at the same point as when they last performed the task on the original device. The connectivity between devices may be wireless, such as radio frequency, infrared, wireless networking, or the like, or wired, such as universal serial bus (USB) or the like. When the user continues a task or starts a new task, the follow-me utility automatically and transparently updates files and task states on any devices having the follow-me utility and connectivity. The follow-me utility may make intelligent task migration decisions based on conditions such as network bandwidth, security policy, location, and device capability.

The user does not have to follow a special process for the task to follow him or her from device to device. The follow-me process does not require a server infrastructure to be in place and does not require continuous network connectivity. A task can be migrated from a first device to a third device via a second device, without requiring the user to actually use the third device and without requiring a direct connection from the first device to the third device. The task can migrate from the first device to the second device and then from the second device to the third device. As long as the new device has an application capable of continuing the task, the application does not have to be the same application that was running the task on the previous device. If the new device does not have an application capable of continuing the task, then the follow-me utility may optionally provision an application from a repository or provisioning service. The follow-me utility may also include intelligence such that it makes task migration decisions based on conditions such as network bandwidth, security policy, location, and device capability. The follow-me utility may also include a capability to set the number of a task's state attributions that get migrated to a new device. Multiple tasks can follow the user from device to device. For example, the number of tasks that are resumed on a device may be configurable. Which tasks are resumed may be based on a policy, such as the most recent tasks.

It should be appreciated that the illustrative embodiments may take the form of a specialized hardware embodiment, a software embodiment that is executed on a computer system having general processing hardware, or an embodiment containing both specialized hardware and software elements that are executed on a computer system having general processing hardware. In one exemplary embodiment, the mechanisms of the illustrative embodiments are implemented in a software product, which may include but is not limited to firmware, resident software, microcode, etc.

Furthermore, the illustrative embodiments may take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium may be an electronic, magnetic, optical, electromagnetic, or semiconductor system, apparatus, or device. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include compact disk-read-only memory (CD-ROM), compact disk-read/write (CD-R/W) and DVD.

The program code of the computer program product may comprise instructions that are stored in a computer readable storage medium in a client or server data processing system. In a client data processing system embodiment, the instructions may have been downloaded over a network from one or more remote data processing systems, such as a server data processing system, a client data processing system, or a plurality of client data processing systems using a peer-to-peer communication methodology. In a server data processing system embodiment, the instructions may be configured for download, or actually downloaded, over a network to a remote data processing system, e.g., a client data processing system, for use in a computer readable storage medium with the remote data processing system.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for migrating a task between devices, the method comprising:
identifying a task currently executing on a first device;
saving task state information associated with the task on the first device;
responsive to a second device establishing a communicative coupling with the first device, automatically transferring the task state information to the second device; and
automatically initializing the task on the second device according to the task state information so that the task can resume execution at a point at which the task was transferred to the second device.

2. The method of claim 1, wherein the task state information comprises at least one of a document, cursor location, page being viewed, window location, window size, insert/overwrite mode, or selected text.

3. The method of claim 1, wherein a communicative coupling comprises a wired network connection, a wireless network connection, a wired direct connection, a universal serial bus connection, an Ethernet connection via a crossover cable, or a wireless direct connection.

4. The method of claim 1, wherein the communicative coupling comprises a communication session that includes a security measure to ensure that the task state information is not distributed to unauthorized devices.

5. The method of claim 1, wherein the task state information comprises a first document, the method further comprising:
responsive to a third device establishing a communicative coupling with the first device, automatically receiving a second document and associated task state information from the third device.

6. The method of claim 5, further comprising:
initializing the second document on the first device based on a device profile associated with the first device.

7. The method of claim 6, wherein the device profile comprises at least one of screen resolution, amount of memory, processor speed, application information, or security level.

8. The method of claim 6, wherein initializing the second document comprises:
identifying a first application in which the document was created on the third device;
determining that the first device does not have the first application;
identifying a second application on the first device that is compatible with the first document; and
opening the document using the second application.

9. The method of claim 6, wherein initializing the second document comprises:
identifying a first application in which the document was created on the third device;
determining that the first device does not have the first application; and
provisioning the first application from a provisioning service.

10. The method of claim 6, wherein initializing the second document comprises:
identifying a first application in which the document was created on the third device;
determining that the first device does not have the first application
identifying a second application that is compatible with the first document; and
determining that the first device does not have the second application; and
provisioning the second application from a provisioning service.

11. The method of claim 5, further comprising:
forwarding the second document and associated task state information to a fourth device without the third device and fourth device having a communicative coupling therebetween.

12. A system within a first device, comprising:
a processor in the first device; and
a memory in the first device, wherein the memory comprises instructions, which when executed by the processor, cause the processor to:
identify a task currently executing on the first device;
save task state information associated with the task on the first device; and
responsive to a second device establishing a communicative coupling with the first device, automatically transfer the task state information to the second device such that the second device automatically initializes the task on the second device according to the task state information so that the task can resume execution at a point at which the task was transferred to the second device.

13. The system of claim 12, wherein the task state information comprises at least one of a document, cursor location, page being viewed, window location, window size, insert overwrite mode, or selected text.

14. The system of claim 12, wherein a communicative coupling comprises a wired network connection, a wireless network connection, a wired direct connection, a universal serial bus connection, an Ethernet connection via a crossover cable, or a wireless direct connection.

15. The system of claim 12, wherein the communicative coupling comprises a communication session that includes a security measure to ensure that the task state information is not distributed to unauthorized devices.

16. The system of claim 12, wherein the task state information comprises a first document, wherein the instructions further cause the processor to:
responsive to a third device establishing a communicative coupling with the first device, automatically receive a second document and associated task state information from the third device.

17. The system of claim 16, wherein the instructions further cause the processor to:
initialize the second document on the first device based on a device profile associated with the first device.

18. A computer program product comprising a computer useable medium having a computer readable program, wherein the computer readable program, when executed on a computing device, causes the computing device to:
identify a task on the first device;
save task state information associated with the task on the first device; and
responsive to a second device establishing a communicative coupling with the first device, automatically transfer the task state information to the second device such that the second device automatically initializes the task on the second device according to the task state information so that the task can resume execution at a point at which the task was transferred to the second device.

19. The computer program product of claim 18, wherein the computer readable program comprises instructions that are stored in a computer readable storage medium in a data processing system, and wherein the instructions were downloaded over a network from a remote data processing system.

20. The computer program product of claim 18, wherein the computer readable program comprises instructions that are stored in a computer readable storage medium in a server data processing system, and wherein the instructions are downloaded over a network to a remote data processing system for use in a computer readable storage medium with the remote data processing system.
